(19) United States
(12) Patent Application Publication
(10) Pub. No.: US 2019/0367362 A1
(43) Pub. Date: Dec. 5, 2019

(54) OZONE GENERATOR

(71) Applicants: KABUSHIKI KAISHA TOSHIBA, Minato-ku (JP); TOSHIBA INFRASTRUCTURE SYSTEMS & SOLUTIONS CORPORATION, Kawasaki-shi (JP)

(72) Inventors: Michiko HASHIMOTO, Atsugi (JP); Takaaki MURATA, Kawasaki (JP); Kie KUBO, Toshima (JP); Yuji OKITA, Kawasaki (JP)

(73) Assignees: KABUSHIKI KAISHA TOSHIBA, Minato-ku (JP); TOSHIBA INFRASTRUCTURE SYSTEMS & SOLUTIONS CORPORATION, Kawasaki-shi (JP)

(21) Appl. No.: 16/485,624

(22) PCT Filed: Sep. 19, 2017
(86) PCT No.: PCT/JP2017/033783

§ 371 Date: Aug. 13, 2019

(30) Foreign Application Priority Data
Feb. 17, 2017 (JP) 2017-028189

(51) Int. Cl. C01B 13/11; H01T 19/00

(52) U.S. Cl. CPC C01B 13/115; H01T 19/00; C01B 2201/32; C01B 2201/22; C01B 2201/14

(57) ABSTRACT

An ozone generator includes a first end plate, a second end plate located opposite the first end plate, a metallic electrode held at both ends by the first and second end plates, a dielectric located inside the metallic electrode with a discharge gap, and including an open end on a first end plate side and a closed end on a second end plate side, a conductive film located on an inner surface of the dielectric, and a high voltage feeding terminal electrically coupled to the conductive film. The conductive film and the high voltage feeding terminal are at least partially in a same position as the first end plate in axial direction of the dielectric. An end of the conductive film and an end of the high voltage feeding terminal on a dielectric opening side extend further toward the opening of the dielectric than the first end plate in the axial direction.

### FIELD

Embodiments relate to an ozone generator.

### BACKGROUND

An ozone generator includes a tubular metallic electrode both ends of which are held by end plates, a discharge tube including a conductive film formed inside a tubular dielectric placed inside the metallic electrode, and a high voltage feeding terminal connected to the conductive film. The ozone generator causes a silent discharge in a discharge gap between the metallic electrode and the conductive film, thereby generating ozone. The generated ozone is used for various purposes including advanced water purification treatment, and clarification, sterilization, oxidation, decolorization, and deodorization of industrial waste water and sewage, for example.

Such an ozone generator includes the conductive film and the high voltage feeding terminal extending to the position of the end plate which needs to cause a silent discharge, thereby ensuring a discharge region.

### CITATION LIST

### Patent Literature

Patent Literature 1: Japanese Patent Application Laid-open No. 2012-144425

### SUMMARY OF THE INVENTION

### Problem to be Solved by the Invention

The above ozone generator, however, generates an electric field from the outer ends of the conductive film and the high voltage feeding terminal to the end plate, so that anomalous discharge may occur, which would deteriorate the components.

### Means for Solving the Problem

In view of solving the problem and attaining an object, an ozone generator includes a first end plate, a second end plate, a metallic electrode, a dielectric, a conductive film, and a high voltage feeding terminal. The second end plate is located opposite the first end plate. The metallic electrode is tubular and held at both ends by the first end plate and the second end plate. The dielectric is located inside the metallic electrode with a discharge gap, and tubular with an open end on a first end plate side and a closed end on a second end plate side. The conductive film is located on an inner surface of the dielectric. The high voltage feeding terminal is electrically coupled to the conductive film. The conductive film and the high voltage feeding terminal are at least partially in the same position as the first end plate in an axial direction of the dielectric. An end of the conductive film and an end of the high voltage feeding terminal on an opening side of the dielectric extend further toward the opening of the dielectric than the first end plate in the axial direction of the dielectric.

### BRIEF DESCRIPTION OF DRAWINGS

FIG. 1 is a sectional view illustrating the entire structure of an ozone generator according to a first embodiment;

FIG. 2 is an enlarged sectional view of the vicinity of a dielectric electrode of the first embodiment;

FIG. 3 is an enlarged sectional view of the vicinity of a dielectric electrode of a second embodiment;

FIG. 4 is an enlarged sectional view of the vicinity of a dielectric electrode of a third embodiment;

FIG. 5 is a view illustrating a result of a first simulation of an example of the first embodiment;

FIG. 6 is a view illustrating a result of the first simulation of a first comparative example;

FIG. 7 is a view illustrating a result of the first simulation of a second comparative example;

FIG. 8 is a graph on which the results of the first simulation of FIG. 5 to FIG. 7 are plotted; and

FIG. 9 is a graph on which maximum electric fields of results of the second simulation of examples of the third embodiment are plotted.

### DETAILED DESCRIPTION

The following exemplary embodiments and modifications include the same or like elements. Thus, same or like elements are denoted by the common reference numerals and overlapping descriptions are partially omitted below. Part of an embodiment or a modification can be replaced with a corresponding part of another embodiment or modification. A structure, position, and the like of part of an embodiment or a modification are similar to those of another embodiment or modification unless otherwise stated.

### First Embodiment

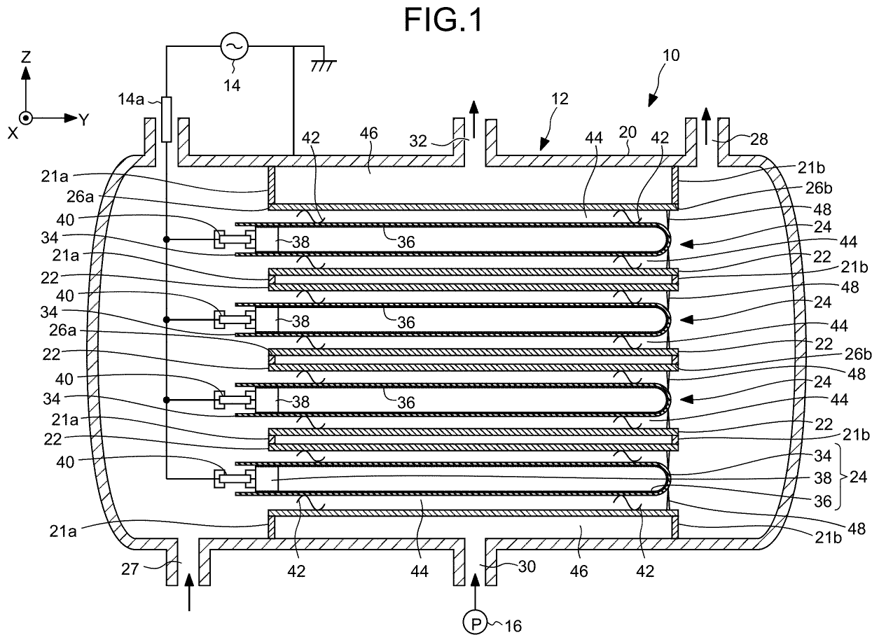

FIG. 1 is a sectional view illustrating the entire structure of an ozone generator 10 according to a first embodiment. The directions represented by X-axis, Y-axis, and Z-axis indicated by the arrows in FIG. 1 are defined to be an X direction, a Y direction, and a Z direction, respectively. As illustrated in FIG. 1, the ozone generator 10 includes an apparatus body 12, a high-voltage power supply 14, and a cooling water supplier 16.

The apparatus body 12 includes an airtight container 20, a pair of end plates 21a, 21b, a plurality of metallic electrodes 22, a plurality of dielectric electrodes 24, a fuse 40, a spacer 42, and a positioning member 48.

The airtight container 20 has a hollow cylindrical shape having an axis in the Y direction. The airtight container 20 houses and holds the end plates 21a, 21b, the metallic electrodes 22, the dielectric electrodes 24, the fuse 40, the spacer 42, and the positioning member 48. The outer periphery of the airtight container 20 is connected to a gas inlet 27, a gas outlet 28, a cooling water inlet 30, and a cooling water outlet 32. A feed gas containing oxygen is supplied from the outside through the gas inlet 27 into the airtight container 20. The gas outlet 28 discharges an unreacted feed gas and ozone (O₃) to the outside. The cooling water inlet 30 is located at the bottom of the airtight container 20. Cooling water flows into the cooling water inlet 30 from the cooling water supplier 16. The cooling water outlet 32 is located at the top of the airtight container 20. The cooling water outlet 32 discharges the cooling water to the outside.

The end plates 21a, 21b contain a conductive material such as stainless steel. The end plates 21a, 21b have a discoid shape. The outer periphery of the end plates 21a, 21b is fixed to the airtight container 20. The end plate 21b is located opposite the end plate 21a in substantially parallel to the end plate 21a. The end plates 21a, 21b are connected to ground potential through the airtight container 20. The end plates 21a, 21b are each provided with a plurality of circular holes 26a, 26b of substantially the same shape as that of an end of the metallic electrodes 22.

The metallic electrodes 22 contain the same material as the end plates 21a, 21b, the material being a conductive material such as stainless steel, and have electrical conductivity. The metallic electrodes 22 are arranged inside the airtight container 20. The metallic electrodes 22 are disposed at substantially equal intervals in the X direction and the Z direction, with the longitudinal side of each metallic electrode 22 extending in the Y direction. The metallic electrodes 22 have a tubular shape (a cylindrical shape, for example) with an axis in the Y direction in parallel to the axis of the airtight container 20. One end of each metallic electrode 22 is coupled to the corresponding circular hole 26a of one of the end plates 21a. The other end of the metallic electrode 22 is coupled to the corresponding circular hole 26b of the other end plate 21b. Thus, both ends of the metallic electrode 22 are not closed but held by the end plates 21a, 21b and are electrically connected to the end plates 21a, 21b. The ends of the metallic electrode 22 are coupled to the end plates 21a, 21b by welding, for example. The metallic electrodes 22 are connected to ground potential through the end plates 21a, 21b. Of the metallic electrodes 22, the metallic electrodes 22 located at the outermost circumference each form a cooling-water channel 46 with the inner circumference of the airtight container 20. The channels 46 are connected to the cooling water inlet 30 and the cooling water outlet 32 of the airtight container 20. The channels 46 are also connected to inner hollows of the metallic electrodes 22 in the middle other than the metallic electrodes 22 located at the outermost circumference.

Each dielectric electrode 24 is located in the airtight container 20 inside any of the metallic electrodes 22. The dielectric electrode 24 includes a dielectric 34, a conductive film 36, and a high voltage feeding terminal 38.

The dielectric 34 contains a dielectric material such as silica glass, borosilicate glass, high silicate glass, aluminosilicate glass, and ceramic, and is electrically isolated. The dielectric 34 has a tubular shape (a cylindrical shape, for example). The dielectric 34 has a length of 60 mm, for example, in the axial direction. The dielectric 34 has an open end on the end plate 21a side. The dielectric 34 has a closed end which tapers toward the tip, on the end plate 21b side. The dielectric 34 is located inside any of the metallic electrodes 22 with a discharge gap 44. The dielectric 34 is placed such that the axis of the dielectric 34 is in substantially parallel to the axes of the airtight container 20 and the metallic electrodes 22 and that the outer circumference of the dielectric 34 opposes the inner circumferences of the metallic electrodes 22. The end of the dielectric 34 on the opening side protrudes more outward than the end plate 21a.

The conductive film 36 contains a conductive material such as stainless, nickel, carbon, or aluminum, and has electrical conductivity. The conductive film 36 is formed on the inner surface of the dielectric 34 by sputtering, thermal spraying, vapor deposition, electroless plating, electrolytic plating, or coating, for example, of a conductive material. Thus, the conductive film 36 has a tubular shape (a cylindrical shape, for example).

The high voltage feeding terminal 38 contains a conductive material and has electrical conductivity. For example, the high voltage feeding terminal 38 has a porous columnar structure made of a fibrous conductive material. The high voltage feeding terminal 38 is placed in the vicinity of the end of the dielectric 34 on the end plate 21a side. The high voltage feeding terminal 38 is electrically connected to the conductive film 36 and the fuse 40.

The fuse 40 is placed with the axis thereof coinciding with the axis of the dielectric 34. One end of the fuse 40 is electrically connected to the high-voltage power supply 14 through a high-voltage insulator 14a. The other end of the fuse 40 is electrically connected to the high voltage feeding terminal 38. In the case of a breakage of the dielectric 34 due to a dielectric breakdown, the fuse 40 serves to interrupt an overcurrent flowing through the conductive film 36 and isolates a broken discharge tube from the other discharge tubes. Thereby, the ozone generator can continue the operation.

The spacer 42 is located between the corresponding metallic electrode 22 and the dielectric electrode 24. Thus, the spacer 42 maintains the discharge gap 44 between the metallic electrode 22 and the conductive film 36 at a certain gap. Specifically, the spacer 42 retains the discharge gap 44.

Each positioning member 48 positions the corresponding dielectric electrode 24 in the axial direction. The positioning member 48 is located on the inner surface of the metallic electrode 22, and abuts on the closed end of the dielectric 34 on the end plate 21b side when inserted into the metallic electrode 22. In this manner, the positioning member 48 restrains the dielectric 34 from being inserted deeper into the metallic electrode 22, thereby positioning the dielectric 34 of the dielectric electrode 24.

The high-voltage power supply 14 is connected to the high voltage feeding terminal 38 through the fuse 40. The high-voltage power supply 14 applies a high alternating voltage to the conductive film 36 through the fuse 40 and the high voltage feeding terminal 38.

The cooling water supplier 16 represents a chiller or a pump, for example. The cooling water supplier 16 is connected to the cooling water inlet 30 of the airtight container 20, and supplies cooling water from the cooling water inlet 30 to the channel 46 inside the airtight container 20.

The operation of the ozone generator 10 is described next. The ozone generator 10 is supplied with a feed gas through the gas inlet 27 and the high-voltage power supply 14 supplies an alternating voltage between the metallic electrodes 22 and the respective conductive films 36 while the metallic electrodes 22 is cooled by cooling water supplied through the cooling water inlet 30. Thereby, the feed gas between the conductive film 36 and the metallic electrodes 22 is applied with a high voltage, and a silent discharge occurs in the discharge gap 44, which causes ozone from oxygen in the feed gas, and the ozone is discharged from the gas outlet 28.

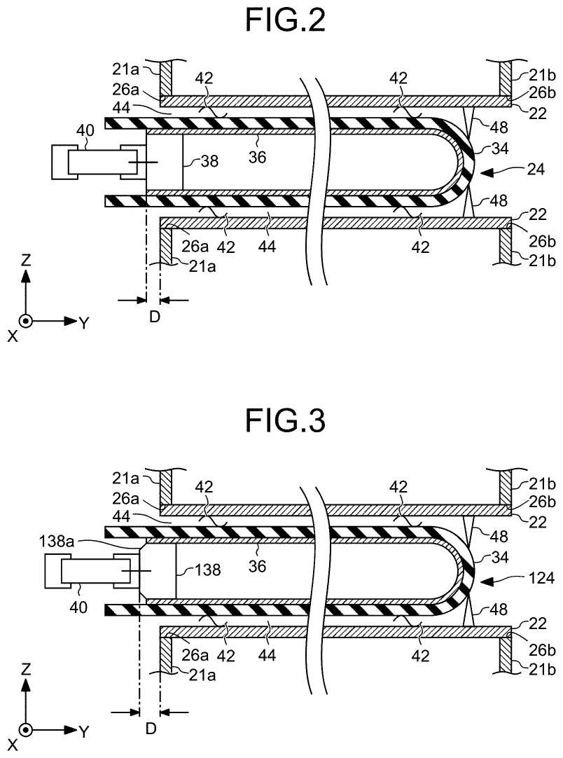

FIG. 2 is an enlarged sectional view of the vicinity of the dielectric electrode 24 of the first embodiment.

As illustrated in FIG. 2, the conductive film 36 and the high voltage feeding terminal 38 are at least partially located in the same position as the end of the metallic electrode 22 and the end plate 21a in the axial direction (Y direction) of the dielectric 34. Thereby, the conductive film 36 and the high voltage feeding terminal 38 are at least partially aligned with the end of the metallic electrode 22 and the end plate 21a as viewed from a direction (that is, the X direction or the Z direction) in parallel to the face of the end plate 21a. The conductive film 36 and the high voltage feeding terminal 38 at least partially pass through the hole 26a of the end plate 21a. The end of the high voltage feeding terminal 38 on the end plate 21a side extends to the same position as the end of the conductive film 36 on the end plate 21a side in the axial direction (the Y direction) of the dielectric 34. In the axial direction (the Y direction) of the dielectric 34, the end of the conductive film 36 and the end of the high voltage feeding terminal 38 on the opening side of the dielectric 34 extend further toward the opening of the dielectric 34 (that is, outside the metallic electrodes 22) than the end of the metallic electrode 22 on the end plate 21a side and the end plate 21a. For example, the protrusion amounts D of the end of the conductive film 36 and the end of the high voltage feeding terminal 38 from the end of the metallic electrode 22 on the end plate 21a side and the end plate 21a are 5 mm to 30 mm.

As described above, in the ozone generator 10, the end of the conductive film 36 and the end of the high voltage feeding terminal 38 can be longer in distance from the end of the metallic electrode 22 and the end plate 21a, as compared with both of them being in the same position as the end of the metallic electrode 22 and the end plate 21a. Thereby, the ozone generator 10 can be downsized, with the high voltage feeding terminal 38 being partially located in the same position as the end plate 21a, and can prevent an anomalous discharge by relaxing the electric field between the high voltage feeding terminal 38, and the end plate 21a and the metallic electrode 22. As a result, the ozone generator 10 can prevent the conductive film 36 from being damaged, and elongate the longevity of the dielectric electrode 24.

In the ozone generator 10, the positioning member 48 can facilitate the positioning of the dielectric 34 of the dielectric electrode 24.

### Second Embodiment

FIG. 3 is an enlarged sectional view of the vicinity of a dielectric electrode 124 of a second embodiment. As illustrated in FIG. 3, the dielectric electrode 124 of the second embodiment includes, at the end of a high voltage feeding terminal 138 on the opening side of the dielectric 34, a taper 138a that tapers along the end face. That is, there is a clearance between the end of the high voltage feeding terminal 138, and the dielectric 34 and the conductive film 36. At least part of the clearance is outward with respect to the end plate 21a. Thereby, at the end of the high voltage feeding terminal 138, the taper 138a can work to disperse concentration of the electric charge on the corner and elongate the distance between the corner, and the end of the metallic electrode 22 and the end plate 21a. As a result, the dielectric electrode 124 can prevent an anomalous discharge between the high voltage feeding terminal 138, and the end plate 21a and the metallic electrode 22.

### Third Embodiment

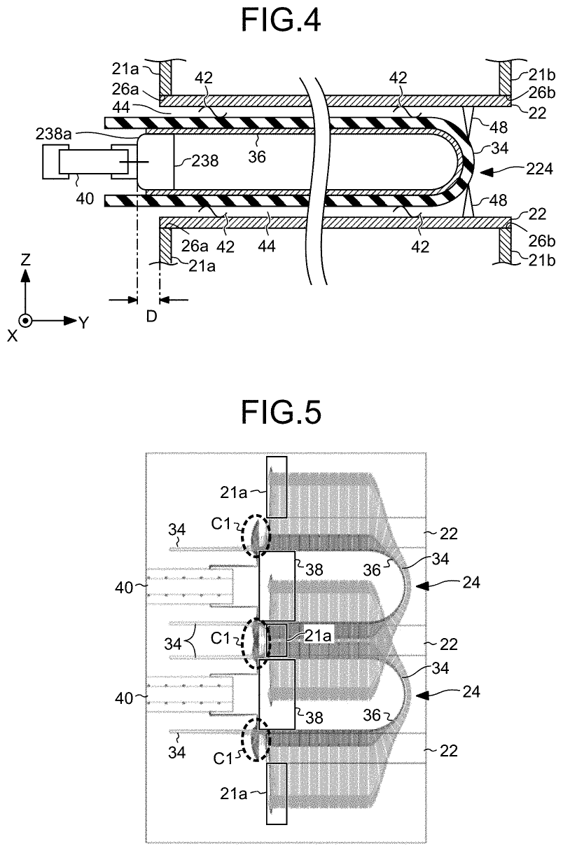

FIG. 4 is an enlarged sectional view of the vicinity of a dielectric electrode 224 of a third embodiment. As illustrated in FIG. 4, the dielectric electrode 224 of the third embodiment includes, at the end of a high voltage feeding terminal 238 on the opening side of the dielectric 34, a curved part 238a having a curved surface that tapers along the end face. That is, there is a clearance between the end of the high voltage feeding terminal 238, and the dielectric 34 and the conductive film 36. At least part of the clearance is outward with respect to the end plate 21a. Thereby, at the end of the high voltage feeding terminal 238, the curved part 238a can work to disperse concentration of the electric charge on the corner, and elongate the distance between the corner, and the end of the metallic electrode 22 and the end plate 21a. As a result, the dielectric electrode 224 can prevent an anomalous discharge between the high voltage feeding terminal 238, and the end plate 21a and the metallic electrode 22.

The following describe simulations for proving the effects of the respective embodiments.

### First Simulation

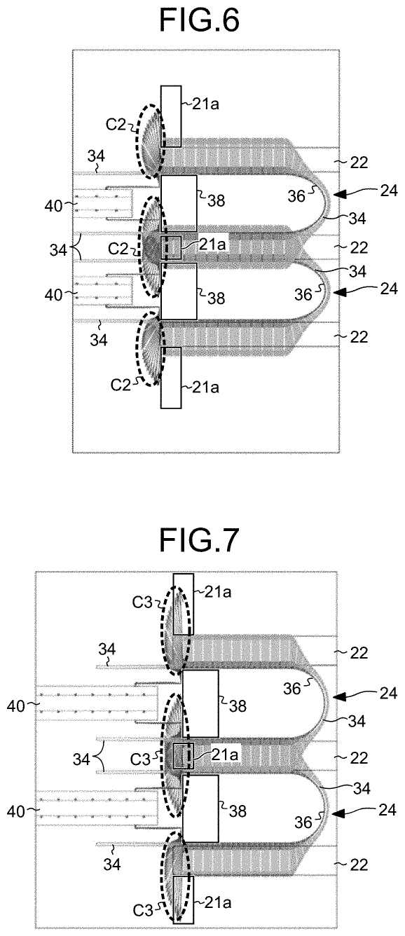

FIG. 5 is a view illustrating a result of a first simulation of a first example. The first example is an example of the first embodiment that the high voltage feeding terminal 38 and the conductive film 36 protrude from the end plate 21a by 5 mm. FIG. 6 is a view illustrating a result of the first simulation of a first comparative example. The first comparative example has the same structure as the first embodiment except that the high voltage feeding terminal 38 and the conductive film 36 are in the same position as the end plate 21a. FIG. 7 is a view illustrating a result of the first simulation of a second comparative example. The second comparative example has the same structure as the first embodiment except that the high voltage feeding terminal 38 and the conductive film 36 are located inward by 5 mm with respect to the end plate 21a. FIG. 5 to FIG. 7 are sectional views of two dielectric electrodes in substantially the same position as in FIG. 2. In the first simulation, the metallic electrodes 22 were grounded by applying a single-phase voltage of 11 kV to the high voltage feeding terminals 38. The simulation results in FIG. 5 to FIG. 7 are results of calculation of the electric fields, and the arrows in the figures indicate the electric fields at the starting points of the arrows. The direction of each arrow represents the direction of the electric field, and the length thereof represents the intensity of the electric field.

It is seen from illustrated in FIG. 5 that the simulation of the first example that the high voltage feeding terminal 38 and the conductive film 36 protrude from the end plate 21a by 5 mm has resulted in small discharge from the end faces of the high voltage feeding terminals 38 (see circles C1 indicated by the dotted lines). Meanwhile, it is seen from FIG. 6 that the simulation of the first comparative example that the high voltage feeding terminal 38 and the conductive film 36 are in the same position as the end plate 21a has resulted in larger discharge from the end faces of the high voltage feeding terminals 38 (see circles C2 indicated by the dotted lines). Likewise, it is seen from FIG. 7 that the simulation of the second comparative example that the high voltage feeding terminal 38 and the conductive film 36 are located inward by 5 mm from the end plate 21a has resulted in larger discharge from the end faces of the high voltage feeding terminals 38 (see circles C3 indicated by the dotted lines).

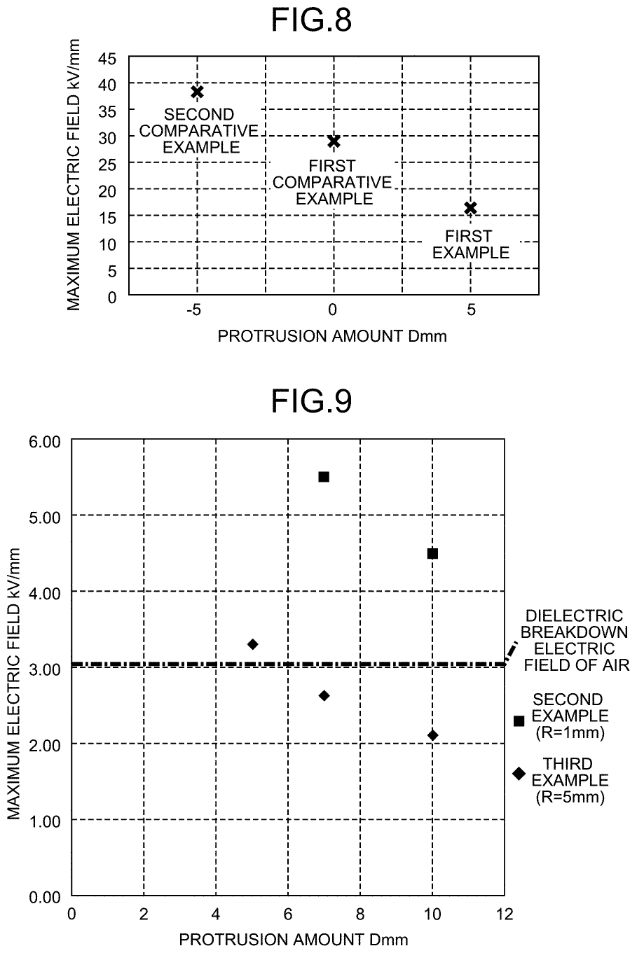

FIG. 8 is a graph on which the first simulation results of FIG. 5 to FIG. 7 are plotted. In FIG. 8 the axis of ordinate represents the maximum electric field, and the axis of abscissa represents the protrusion amount. The protrusion amount takes a positive value when the high voltage feeding terminal 38 and the conductive film 36 protrude from the end plate 21a while it takes a negative value when the high voltage feeding terminal 38 and the conductive film 36 are located inward with respect to the end plate 21a.

It is seen from FIG. 8 that the first example can reduce the maximum electric field in comparison with the first comparative example and the second comparative example. In addition, the protrusion amount D of 5 mm or greater can further reduce the maximum electric field in the first example.

### Second Simulation

FIG. 9 is a graph on which maximum electric fields as results of a second simulation of examples of the third embodiment are plotted. In FIG. 9, the square plots show results of the simulation of a second example that the radius R of the curved part 238a of the third embodiment was set to 1 mm. The rhomboid plots show results of the simulation of a third example that the radius R of the curved part 238a of the third embodiment was set to 5 mm. In the second simulation, the metallic electrodes 22 were grounded by applying a single-phase voltage of 11 kV to the high voltage feeding terminals 238.

It can be seen from FIG. 9 that the second example and the third example of the third embodiment can lower the maximum electric field more than the first example, the first comparative example, and the second comparative example. In addition, the third example with the larger radius R is found to be able to lower the maximum electric field more than the second example with the smaller radius R. In the third example, it is found that the protrusion amount D of 7 mm or greater can decrease the maximum electric field to the dielectric breakdown electric field of air or less.

While certain embodiments of the present invention have been described, these embodiments have been presented by way of example only, and are not intended to limit the scope of the inventions. These novel embodiments may be embodied in a variety of other forms, and various omissions, substitutions and changes may be made without departing from the spirit of the inventions. The accompanying claims and their equivalents are intended to cover these embodiments or modifications thereof as would fall within the scope and spirit of the inventions.

1. An ozone generator comprising:
a first end plate;
a second end plate located opposite the first end plate;
a tubular metallic electrode both ends of which are held by the first end plate and the second end plate;
a tubular dielectric located inside the metallic electrode with a discharge gap, and having an open end on a first end plate side and a closed end on a second end plate side;
a conductive film located on an inner surface of the dielectric; and
a high voltage feeding terminal electrically coupled to the conductive film, wherein
the conductive film and the high voltage feeding terminal are at least partially in the same position as the first end plate in a axial direction of the dielectric, and
in the axial direction of the dielectric, an end of the conductive film and an end of the high voltage feeding terminal on an opening side of the dielectric extend further toward the opening of the dielectric than the first end plate.

2. The ozone generator according to claim 1, wherein
the end of the high voltage feeding terminal on the opening side of the dielectric includes a taper that tapers toward an end face.

3. The ozone generator according to claim 2, wherein
the end of the high voltage feeding terminal on the opening side of the dielectric includes a curved part having a curved surface that tapers toward an end face.

4. The ozone generator according to claim 1, wherein
an end of the dielectric on the second end plate side tapers toward a tip, the ozone generator further comprising
a positioning member located on an inner surface of the metallic electrode, the positioning member that abuts on the end of the dielectric on the second end plate side, to position the dielectric.
